(19) United States
(12) Patent Application Publication
(10) Pub. No.: US 2010/0081742 A1
(43) Pub. Date: Apr. 1, 2010

(54) WATER-BASED POLYURETHANE PIGMENTED COATING

(76) Inventor: James MOORE, Prsippany, NJ (US)

Correspondence Address: DICKSTEIN SHAPIRO LLP, 1633 Broadway, NEW YORK, NY, 10019, US

(21) Appl. No.: 12/531,151

(22) PCT Filed: Mar. 14, 2008
(86) PCT No.: PCT/US08/56933

§ 371 Date: Sep. 14, 2009

(30) Foreign Application Priority Data
Mar. 14, 2007 (US) 61918185

(51) Int. Cl. C08L 75/06; B05D 3/02; C08K 5/06; C08K 5/3415; C08K 5/05; C08K 5/10

(52) U.S. Cl. 524/104; 524/590; 524/591; 427/385.5; 524/366; 524/391; 524/284

(57) ABSTRACT

The present invention is a coating composition for coating materials, such as silica sand and other media, containing a water-based polyurethane dispersion, a colorant, and optional ingredients such as coalescing solvents and cross-linking agents, and a coated silica sand which is strong in color, lightfast, and resistant.

### FIELD OF THE INVENTION

The present invention relates to a water based pigmented polyurethane coating which may be used for the coloration of sand grains and other media.

### BACKGROUND OF THE INVENTION

Colored media such as sand grains and silicas when used in decorative or industrial uses require impermeability or resistance to heat, sunlight, liquids, acids, bases, and the like.

The 3M Corporation developed a high temperature calcination process for coloring sand grains. In this process inorganic pigments and binders are mixed with sand and sent through a high temperature process to bind the color to the sand.

Numerous types of silica sand compositions have been provided in the prior art. For example, U.S. Pat. Nos. 4,041,000 and 5,364,672 and 5,634,307 and 6,338,871 all are illustrative of such prior art. While these units have some resistance to outside agents, they are not impermeable to acids and bases and the like.

U.S. Pat. No. 4,041,000 discloses a fireproof liquid coating composition including water in a substantial proportion as a base or vehicle, in which silica sand, fire clay or the like silica-containing material is dispersed, along with granular zinc oxide, a selected silicate binder and suspending agent such as calcium silicate or sodium silicate, and a minor concentration of a thermoplastic resin binder and suspending agent, such as polyvinyl acetate. An alkali metal fluorosilicate can also be present, if desired, to help dry the composition when it is applied to a surface to be protected against fire, rain and other elements. Coloring agents, preferably selected inorganic oxides, can also be present to suitably color the composition.

U.S. Pat. No. 5,364,672 describes artificial stones from finely divided glass fragments and artificial resins consisting of a (1) transparent cured or thermoplastically deformed synthetic resin which may be dyed, and (2) white, green, brown or mixed fragmented and/or granulated waste glass of grain sizes of from 0.05-3 mm, and (3) transparent, opaque or strongly colored fragmented and/or granulated new glass having grain sizes of from 0.05 to 3 mm and (4) 0-75% by weight of transparent, opaque or strongly colored ground material having grain sizes of from 0.05 to 3 mm, produced from 80-92 parts by weight of waste glass having sizes of from 0.05 to 0.3 mm and 8 to 20 parts by weight of curable synthetic resin, and (5) 0 to 35% by weight of inorganic fillers selected from the group of silica sand, quartz meal, stone meal, natural or synthetic ground and/or granulated silicates having grain sizes from 0.05 to 3 mm, and (6) 0 to 0.5% by weight of dyes and colored pigments.

U.S. Pat. No. 5,634,307 discloses a stone-like coating applied to architectural structures wherein the coating is applied in successive layers, with the outer surface of the coating being sculpted, configured or colored to imitate the appearance of stonework. The coating is an aqueous composition comprising about one part by weight portland white cement, about 0.9 to 1.1 parts by weight white silica sand, about 1.8 to 2.2 parts by weight limestone sand, and about 0.9 to 1.1 parts by volume acrylic liquid solution.

U.S. Pat. No 6,338,871 describes a method of coloring silica sand for use in coating a surface. The method selecting silica sand of a desired grain size and color, the preferred color being substantially white and grain size being any combination of thirty, fifty and eighty mesh. The coating is prepared by air drying acrylic and vinyl emulsions or thermosetting phenolic, polyester and epoxy emulsions. To coat the silica sand, the silica sand tumbles or falls from an elevated position and is sprayed as it tumbles or falls with the prepared coating. The coated silica sand is then pulverized to break up clumped particles formed during application of the coating. A desired color mixture is obtained by mixing coated silica sand of different colors. The coated silica sand is then applied to a desired surface by one of spraying or using a trowel. Titanium dioxide may be applied to the mixture after application to alter a gloss of the mixture.

There remains a need for a coating for silica sand and other media where the coated sand silica and other media is strong in color, maintains or increases lightfastness, and is resistant or impermeable to heat, sunlight, liquids, acids, bases, and the like.

### SUMMARY OF THE INVENTION

The present invention is a water-based polyurethane pigmented coating for silica sand and other media, a method of coating silica sand and other media, and the coated silica sand and other media. The coated silica sand and other media is strong in color, maintains or increases lightfastness and is resistant or impermeable to heat, sunlight, liquids, acids, bases, and the like.

### DETAILED DESCRIPTION OF THE INVENTION

The present invention is a water-based polyurethane pigmented coating for silica sand and other media, a method of coating silica sand and other media, and the coated silica sand and other media.

The coating consists of a water based polyurethane dispersion and a colorant. Optionally the coating may contain a coalescing solvent. Further, the coating may contain a cross linking agent to further improve chemical resistance and adhesion to the media being coated.

Accordingly one embodiment of this invention is a coating composition for coating silica sand and other media which comprises a water-based polyurethane dispersion, a colorant, an optional coalescing solvent, and an optional cross-linking agent. The composition consists essentially of these ingredients although other standard ingredients for coating compositions may be included.

The coating can be used on media such as but not limited to silica, sand, mica, glass, stones, alumina and aluminum and other metals, and other media. The silica includes, but is not limited to clear, transparent or white silica sand grain. The micas include but is not limited to natural mica, synthetic mica, coated mica, metal coated mica, and combinations thereof. The glass includes, but is not limited to clear, transparent, colored or white glass. The stones include, but is not limited to clear, transparent, colored or white stones. Silica sand is the preferred medium.

The water-based polyurethane dispersion can have a polyester, polycarbonate, or polyether backbone with an aliphatic isocyanate or aromatic isocyanate, and combinations thereof and the like. The polyurethane dispersion can also be alloyed with acrylic polymers, alone or in combination with the polyurethanes above. Thus the coating compositions preferably contain a polyurethane produced from polyester, polycarbonate, or polyester reacted with an aromatic or aliphatic isocyanate, more preferably polyester or polycarbonate reacted with an aliphatic isocyanate. The polyurethane dispersion may increase resistance properties of the coating and coated media. To further increase weathering properties and lightfastness of the coated media based on the polyurethane component, a polyester or polycarbonate backbone with an aliphatic isocyanate is preferred. An example of the water-based polyurethane dispersion is Witcobond A-100, an aliphatic polyester-based urethane alloyed with a polyacrylate.

The water based polyurethane dispersions are comprised of 30 to 60% wt polymer. Water is also included in the water-based polyurethane dispersion, and other additives. Thus, the coating compositions of the present invention preferably use water-based polyurethane dispersion which contain about 30 to 60 weight % of polyurethane.

The coating composition of the present invention may contain about 40 to about 90 weight % of the total weight of the coating composition of water-based polyurethane dispersion.

The colorant of the inventive coating may be an organic or inorganic pigment, a dye or any combination thereof. The colorants that can be used include, but are not limited to, inorganic or organic pigments or dyes, in dry form or water based dispersions of organic pigments/inorganic pigments, or organic pigments/dyes or inorganic pigments/dyes, and combinations thereof. If a colorant dispersion is used, it may contain water and other additives.

The colorant may be present in an amount of about 2 wt. % to about 50 wt % based on the total weight of the coating. The coating compositions preferably have one or more colorants in about 2 to about 50 weight % of the total weight of the coating composition. The colorant may be an organic or inorganic pigment or a dye in any known form but preferably either dry or in a water-based solution or dispersion. Examples of colorants include carbon black dispersion, water-based CI Pigment Blue 15:3 dispersion, and dry cobalt blue pigment.

The coating of the present invention may include a coalescing agent including but not limited to ethers, esters and alcohols such as diethylene glycol monohexyl ether, diethylene glycol monobutyl ether, dipropylene glycol monomethyl ether, 1-methyl-2-pyrrolidinone, dipropylene glycol dimethyl ether, 2-butoxy ethanol, propylene glycol monobutyl ether, 1-methoxy -2-propanol, esters of dibasic acids, combinations thereof, and the like.

Thus the coating compositions may contain a coalescing agent which is an ether or an alcohol or an ester or two or three of these combinations. Preferred coalescing agents are diethylene glycol monohexyl ether, diethylene glycol monobutyl ether, dipropylene glycol monomethyl ether, 1-methyl-2-pyrrolidinone, dipropylene glycol dimethyl ether, 2-butoxy ethanol, propylene glycol monobutyl ether, 1-methoxy -2-propanol, alone or in combination. Another preferred coalescing agent is esters of dibasic acids. An example of a coalescing agent is butyl carbitol.

The coalescing agent may be present in the coating in an amount from about 3 wt. % to about 6 wt. % based on the total weight of the coating. The preferred amount of coalescing agent is about 4 to about 5 weight % of the total weight of the coating composition.

The coating may contain a cross linking agent including but not limited to polyaziredenes, carbodimide, isocyanates, epoxies, melamines, zirconium salt, silanes, combinations thereof, and the like. The cross linking agent may provide additional adhesion and resistance properties for the coating and coated media as well as stability and shelf life for the coating. Thus, the coating compositions may contain a cross-linking agent which is preferably a polyaziredene, a carbodimide, an isocyanate, an epoxy, a melamine, a zirconium salt, or a silane, alone or combination. An example of a cross-linking agent is Coatosil 1770, β-(3,4-epoxycyclohexyl) ethyltriethoxysilane.

The cross linking agent may be present in an amount of about 0.1 wt. % to about 10 wt. % based on the total weight of the coating.

The coating composition of the invention is chemically resistant to acids, bases and many solvents. The coating is also abrasion resistant. The coating has good color strength and lightfastness.

The method of coating the silica sand and other media includes, but is not limited to mixing the coating components such that the coalescing agent, if present, in the mixture has time to swell the polyurethane before applying to the sand, from about 2 hours to about 10 hours, preferably about four hours. If desired, a cross linking agent is then added, such as silane which can provide several months of useable shelf life of the coating. The coating is then applied to the media at a ratio of from about 1 part coating to about 25 parts media, to a ratio of about 1 part coating to about 150 parts media. The coating is applied to the media by taking the media and the coating and combining them via any known method of shaking, tumbling, extruding or in any way mixing the media and coating together. The coated media may be dried to a desired dryness through any known means including but not limited to air drying, oven drying, drying with a rotary kiln, drying in a fluid bed drier, any combination thereof, or any other drying mechanism.

Accordingly the invention includes a method for coating silica sand by combining the silica sand with a coating composition provided herein; agitating the resulting mixture; and drying the resulting mixture to obtain a coated silica sand composition. If the coating composition includes a coalescing agent, then preferably the agent is added to the coating composition from about 2 hours to about 10 hours and more preferably 4 hours before the silica sand and coating composition are combined with each other. If the composition includes a cross-linking agent, the agent is preferably added after the swelling period and before the coating composition is mixed with the silica sand. A preferred cross-linking agent is silane. The above methods consist essentially of the steps provided in the order provided, although other steps may be included before the first step, after the last step, or interspersed between.

The coating obtained by the present methods is chemically resistant to acids, bases and many solvents. The coating obtained by the present methods is also abrasion resistant. The coating obtained by the present methods has good color strength and lightfastness.

When the coating us used to coat silica sand or another medium, the coated silica sand or other medium resulting is colored, free flowing, and non-clumping. The coated silica sand and other media is chemically resistant to acids, bases and many solvents and is also strong in color and has maintained or improved lightfastness. The coated silica sand and other media is also abrasion resistant. Thus another composition of this invention is a silica sand composition which comprises a colored, free-flowing, nonclumping silica sand coated with the any coating composition of this invention.

The coated media can be used as play sand, artist sand, landscaping sand, landscaping glass or stone, flooring, pool lining, and may used in mortars, grouts, concrete or any cementitious material. The coated media may also be used in any application that need a hard colored aggregate.

The water based polyurethane pigmented coating and the coated media of the present invention and method for producing same are further illustrated by the following non-limiting examples in which all parts and percentages are by weight, based on the total weight of the coating, unless otherwise indicated.

### EXAMPLE 1

10 wt. % of a colorant (carbon black dispersion) was mixed with 82 wt. % of a polyurethane dispersion (Witcobond A-100, an aliphatic polyester based urethane alloyed with a polyacrylate), 6 wt. % of a coalescing agent (butyl carbitol) and 2 wt. % of a cross linking agent (Coatosil 1770).

A silica sand was coated with the inventive coating and when tested exhibited resistance to acids, bases and other solvents. The inventive coated silica sand showed improved lightfastness and color strength than conventional pigmented silica sand.

### EXAMPLE 2

10 wt. % of a colorant (water based CI Pigment Blue 15:3 dispersion) was mixed with 82 wt. % of a polyurethane dispersion (Witcobond A-100, an aliphatic polyester based urethane alloyed with a polyacrylate), 6 wt. % of a coalescing agent (butyl carbitol) and 2 wt. % of a cross linking agent (Coatosil 1770).

A silica sand was mixed with the coating and dried. The coated silica sand exhibited resistance to abrasion, acids, bases and other solvents. The inventive coated silica sand showed improved lightfastness and color strength than conventional pigmented silica sand.

### EXAMPLE 3

A polyurethane dispersion was mixed with a water based pigmented dispersion, a coalescing agent, and a silane cross linking agent. The coating was mixed with silica sand at a ratio of 1 part coating to 100 parts sand. The mixing was done in an extruder and the coated silica sand was dried. The resulting product is colored sand that is chemically resistant, abrasion resistant, free flowing and ready to bag.

### EXAMPLE 4

30 wt. % of a colorant (dry cobalt blue pigment) was mixed with 6 wt. % dispersant (Vancryl 68, a styrenated acrylic solution resin), 5 wt. % of a coalescing agent (butyl carbitol) and 1.5% of a cross-linking agent (Coatosil 1770), 45.5 wt. % a polyurethane dispersion (Witcobond A-100, an aliphatic polyester based urethane alloyed with a polyacrylate) and 12.5 wt. % of water.

A silica sand was mixed with the coating and dried. The coated silica sand exhibited resistance to abrasion, acids, bases and other solvents. The inventive coated silica sand showed improved lightfastness and color strength than conventional pigmented silica sand.

### EXAMPLE 5

The coated sand of this invention was tested for resistance to alkalines, acids, and solvents. Black sand and white sand were tested for resistance to a panel of chemicals. As can be seen from the data below, in almost all cases the colored sand was resistant to the chemicals after eighteen or more hours of exposure.

Samples were prepared and tested as follows: A 25 gram sample of color coated sand according to the invention was poured into a 200 ml beaker. 50 ml of test solution was added to the beaker. The mixture was swirled to mix the test solution and inventive coated sand. The beaker was then covered and placed under a fume hood. The inventive coated sand sample was visually inspected after the required exposure time and observations reported. All tests were conducted at room temperature, 65° F. The exposure time was 18 hours for all samples except aluminum sulfate 25%, which had a 90 hour exposure time. All samples were tested under two conditions: 1. after air drying, and 2. after heat cure at 250° F. for one hour.

Tables 1-3 below show the inventive coating results in an inventive coated media which is colored, free flowing, and non-clumping. The inventive coated media is chemically resistant to acids, bases and many solvents and is also strong in color and has maintained or improved lightfastness. The inventive coated media is also abrasion resistant.

TABLE 1
Alkaline Resistance

| Sample ID | Air Dried | Heat Cured | Test Solution |
|---|---|---|---|
| Black coated sand* | No Reaction | No Reaction | TSP 40% |
| | | | Concentration |
| Coated sand (white)* | No Reaction | No Reaction | TSP 40% |
| | | | Concentration |
| Coated sand (black) | No Reaction | No Reaction | Sodium Carbonate |
| | | | 40% Concentration |
| Coated sand (white) | No Reaction | No Reaction | Sodium Carbonate |
| | | | 40% Concentration |
| Coated sand (black) | No Reaction | No Reaction | Ammonium |
| | | | Hydroxide 28% |
| | | | Concentration |
| Coated sand (white) | No Reaction | No Reaction | Ammonium |
| | | | Hydroxide 28% |
| | | | Concentration |
| Coated sand (black) | No Reaction | No Reaction | 1 part Industrial |
| | | | Detergent (Earth |
| | | | Formula 1) to 2 parts |
| | | | water |
| Coated sand (white) | Liquid turned light | Liquid turned light | 1 part Industrial |
| | white | white | Detergent (Earth |
| | | | Formula 1) to 2 parts |
| | | | water |
| Coated sand (black) | No Reaction | No Reaction | Sodium Hydroxide |
| | | | 25% |
| Coated sand (white) | No Reaction | No Reaction | Sodium Hydroxide |
| | | | 25% |
| Coated sand (black) | No Reaction | No Reaction | Chlorine Bleach full |
| | | | strength |
| Coated sand (white) | No Reaction | No Reaction | Chlorine Bleach full |
| | | | strength |

*Sun Chemical

TABLE 2
Acid Resistance

| Sample ID | Air Dried | Heat Cured | Test Solution |
|---|---|---|---|
| Coated sand | No Reaction | No Reaction | Acid 70% |
| (black)* | | | Concentration |
| Coated sand | No Reaction | No Reaction | Acid 70% |
| (white)* | | | Concentration |
| Coated sand | No Reaction | No Reaction | Hydrochloric Acid |
| (black) | | | 37% Concentration |
| Coated sand | No Reaction | No Reaction | Hydrochloric Acid |
| (white) | | | 37% Concentration |
| Coated sand | No Reaction | No Reaction | Acetic Acid 100% |
| (black) | | | Concentration |
| Coated sand | No Reaction | No Reaction | Acetic Acid 100% |
| (white) | | | Concentration |
| Coated sand | No Reaction | No Reaction | Aluminum Sulfate |
| (black) | | | 25% Concentration |
| Coated sand | No Reaction | No Reaction | Aluminum Sulfate |
| (white) | | | 25% Concentration |
| Coated sand | No Reaction | No Reaction | Trichloro-s- |
| (black) | | | triazenetrione, |
| | | | saturated |
| Coated sand | Liquid turned light | No Reaction | Trichloro-s- |
| (white) | white | | triazenetrione, |
| | | | saturated |
| Coated sand | No Reaction | No Reaction | Dichloro-s- |
| (black) | | | triazenetrione, |
| | | | saturated |
| Coated sand | Liquid turned light | No Reaction | Dichloro-s- |
| (white) | white | | triazenetrione, |
| | | | saturated |

*Sun Chemical

TABLE 3
Solvent Resistance

| Sample ID | Air Dried | Heat Cured | Test Solution |
|---|---|---|---|
| Coated sand | No Reaction | No Reaction | Mineral Spirits |
| (black)* | | | |
| Coated sand | Liquid turned | Liquid turned | Mineral Spirits |
| (white)* | light white | light white | |
| Coated sand (black) | No Reaction | No Reaction | VMP Naphtha |
| Coated sand (white) | No Reaction | No Reaction | VMP Naphtha |
| Coated sand (black) | No Reaction | No Reaction | Xylene |
| Coated sand (white) | No Reaction | No Reaction | Xylene |
| Coated sand (black) | No Reaction | No Reaction | Toluene |
| Coated sand (white) | No Reaction | No Reaction | Toluene |
| Coated sand (black) | No Reaction | No Reaction | Laquer Thinner |
| Coated sand (white) | Liquid turned | Liquid turned | Laquer Thinner |
| | light white | light white | |
| Coated sand (black) | No Reaction | No Reaction | Acetone |
| Coated sand (white) | Liquid turned | Liquid turned | Acetone |
| | light white | light white | |

*Sun Chemical

It should be understood that the preceding is merely a detailed description of one preferred embodiment or a small number of preferred embodiments of the present invention and that numerous changes to the disclosed embodiment(s) can be made in accordance with the disclosure herein without departing from the spirit or scope of the invention. The preceding description, therefore, is not meant to limit the scope of the invention in any respect. Rather, the scope of the invention is to be determined only by the appended issued claims and their equivalents.

1. A coating composition which comprises a water-based polyurethane dispersion; a colorant selected from organic pigments, inorganic pigments, and dyes; an optional coalescing solvent; and an optional cross-linking agent.

2. The coating composition of claim 1 wherein the water-based polyurethane dispersion contains about 30 to 60 weight % of polyurethane.

3. The coating composition of claim 1 wherein the water-based polyurethane dispersion is about 40 to about 90 weight % of the total weight of the coating composition.

4. The coating composition of claim 1 wherein the polyurethane is the reaction product of polyester, polycarbonate, or polyester with an aromatic or aliphatic isocyanate.

5. The coating composition of claim 4 wherein the polyurethane is the reaction product of polyester or polycarbonate with an aliphatic isocyanate.

6. The coating composition of claim 1 wherein the colorant is about 2 to about 50 weight % of the total weight of the coating composition.

7. The coating composition of claim 6 wherein the colorant is in dry form.

8. The coating composition of claim 6 wherein the colorant is a water-based dispersion.

9. The coating composition of claim 1 which comprises a coalescing agent which is an ether, an alcohol, an ester of a dibasic acid, or a combination thereof.

10. The coating composition of claim 9 wherein the coalescing agent is selected from the group of diethylene glycol monohexyl ether, diethylene glycol monobutyl ether, dipropylene glycol monomethyl Tether, 1-methyl-2-pyrrolidinone, dipropylene glycol dimethyl ether, 2-butoxy ethanol, propylene glycol monobutyl ether, 1-methoxy-2-propanol, esters of dibasic acids, and combinations thereof.

11. The coating composition of claim 10 wherein the coalescing agent is about 3 to about 6 weight % of the total weight of the coating composition.

12. The coating composition of claim 1 wherein the cross-linking agent is selected from the group of polyaziredenes, carbodimide, isocyanates, epoxies, melamines, zirconium salt, silanes, and combinations thereof.

13. The coating composition of claim 12 wherein the cross-linking agent is from about 0.1 to about 10 weight % of the coating composition.

14. A method for coating silica sand which comprises combining the silica sand with the coating composition of claim 1; agitating the resulting mixture; and drying the resulting mixture to obtain a coated silica sand composition.

15. The method of claim 14 wherein the coating composition comprises a coalescing agent which is added to the coating composition from about 2 hours to about 10 hours before the silica sand and the coating composition are combined.

16. The method of claim 15 wherein the coalescing agent is added about 4 hours before the silica sand and the coating composition are combined.

17. The method of claim 14 wherein a cross-linking agent is added shortly prior to combining the silica sand and the coating composition.

18. The method of claim 17 wherein the cross-linking agent is silane.

19. A material coated with the coating composition of claim 1.

20. The coated material of claim 19 wherein the material is selected from the group consisting of sand, silica, mica, glass, flooring, pool lining, mortar, grout, concrete, another cementitious material, and combinations thereof.

21. A silica sand composition which comprises a colored, free-flowing, nonclumping silica sand coated with the coating composition of claim 1.

22. The coated material of claim 19 wherein the material is a landscaping material.

23. (canceled)

24. The coating composition of claim 4 wherein the coalescing agent is an ether, an alcohol, an ester of a dibasic acid, or a combination thereof.

25-26. (canceled)

27. The coated material of claim 22 wherein the landscaping material is glass, flooring, pool lining, mortar, grout, concrete, another cementitious material, and combinations thereof.

28. The coating composition of claim 4 wherein the water-based polyurethane dispersion contains about 30 to 60 weight % of polyurethane, the water-based polyurethane dispersion is about 40 to 90 weight % of the total weight of the composition, the colorant is about 2 to about 50 weight % of the total weight of the coating composition, the coalescing agent is about 3 to about 6 weight % of the total weight of the coating composition, and the cross-linking agent is from about 0.1 to about 10 weight % of the coating composition.
